(19) United States
(12) Patent Application Publication
(10) Pub. No.: US 2025/0098664 A1
(43) Pub. Date: Mar. 27, 2025

(54) FLEXIBLE POLYMERIC VESSEL AND HEATING ELEMENT AND RELATED METHODS

(71) Applicant: ENTEGRIS, INC., Billerica, MA (US)

(72) Inventor: Michael W. Johnson, St. Louis Park, MN (US)

(21) Appl. No.: 18/892,209

(22) Filed: Sep. 20, 2024

Related U.S. Application Data
(60) Provisional application No. 63/539,769, filed on Sep. 21, 2023.

(51) Int. Cl. A01N 1/02

(52) U.S. Cl. CPC A01N 1/144; A01N 1/148

(57) ABSTRACT

Described are flexible vessels that are useful for containing a liquid and freezing the liquid, and a flexible resistive heating element that is adapted to heat the frozen liquid to cause the frozen liquid to melt.

### FIELD

The present description relates to flexible vessels that are useful for containing a liquid and freezing the liquid, and flexible resistive heating elements adapted to heat the frozen liquid to cause the frozen liquid to melt.

### BACKGROUND

The life science sector, particularly in areas of biotechnology and cell and gene therapy, involves biologically active materials (also referred to herein as simply “biological materials”) that may be frozen and un-frozen during steps of preparation, transport, and use. The biological materials may be biologically or pharmaceutically active materials such as pharmaceutical compounds, proteins, living (live) cells, or other biological molecules or structures that are useful as pharmaceutical agents, medicines, or as precursors to a pharmaceutical agent or medicine.

These biologically active materials must be packaged, transported, and stored between the time of initially preparing a material and a time of using the material. Highly specialized packages have been developed to safely contain, transport, and store these biologically active materials in a manner that is safe and does not cause damage to the biological material.

Often, biologically active materials are frozen for storage and during transport. Freezing the material can reduce the potential for chemical degradation of a biologically active material or slow or stop metabolic processes in live cells, i.e., slow or stop cell growth. Packages for biological materials are therefore adapted to be frozen and to contain the biological material in a frozen form. Useful package formats include flexible polymeric vessels (sometimes referred to as a “bag” or a “pouch”) adapted to contain and deliver the biologically active material and to allow the biological material to be frozen and un-frozen while in the container. In various formats the flexible vessel is an inner package component that is held by a more rigid outer package component that protects the inner vessel from physical or mechanical damage and that may incorporate additional useful features such as thermal insulation.

Storing and transporting biologically active materials in a frozen state has become a common technique. While very effective for these purposes, and although these techniques offer significant benefits, the steps of freezing and subsequently thawing a biological material also produce potential disadvantages. For example, freezing and thawing a biological material may cause physical damage to active pharmaceutical compounds and live cells, which can cause the biological material to be inactivated.

### SUMMARY

The present description relates to devices and methods that use a flexible vessel to contain, transport, and store a material in either a liquid or a solid (frozen) state. The vessel can initially contain the material in a liquid state and the liquid material can be frozen while being held in the container. The solid (frozen) material can be subsequently thawed using a resistive heating element as described.

The life sciences, pharmaceutical, and biotechnology industries, particularly with respect to cell and gene therapy, transport and store biological materials in a frozen state. After freezing, the material must eventually be thawed. A great deal of attention and research has focused on methods of freezing biological materials. Less research has been directed toward methods of thawing a frozen biological material in a manner to reduce or minimize harm to the materials during the thawing step. Current thawing methods include convection heating and water bath heating, each of which applies an equal amount of heat energy to all areas of an outer surface of a vessel.

The Applicant has identified examples of devices, systems, and methods that use a resistive heating element to apply a heat flux through a surface of a flexible vessel, to thaw a bulk amount of frozen biological material contained in the vessel, and to produce rapid and uniform thawing of the bulk volume of frozen liquid. Rapid and uniform thawing of a bulk volume of frozen biological material in a vessel can be effective to preserve the biological activity of the biological material, particularly of frozen live cells. Additionally, the described vessels and heating elements and related methods can allow for thawing of high value medicines at a point of use (e.g., hospital, medical care clinic, home), i.e., at a location of a patient and a location of administering the medicine to the patient, rather than thawing the biological material at a remote location and transporting the material to a point of use in an un-frozen condition.

In one aspect, the following description relates to a flexible polymeric vessel and heating element. The vessel and heating element include: a vessel comprising a flexible polymeric sidewall having an inner surface that defines a vessel interior adapted to contain a fluid, and an outer surface; and a flexible resistive heating element adapted to provide heat energy through the flexible polymeric sidewall to the interior.

In another aspect, the description relates to a method of thawing a frozen biological material. The method includes: providing frozen biological material contained in a vessel that comprises a flexible polymeric sidewall having an inner surface that defines a vessel interior adapted to contain a fluid, and an outer surface; and thawing the biopharmaceutical fluid using a flexible resistive heating element to provide heat energy through the flexible polymeric sidewall to the interior.

### BRIEF DESCRIPTION OF THE DRAWINGS

FIG. 1 shows an example of a flexible vessel as described.

FIGS. 2A (front view), 2B (side, cut-away view), and 2C (detailed view) show an example of a flexible vessel as described and a resistive heating element.

FIG. 3 shows an example of a flexible vessel as described and a resistive heating element.

FIGS. 4A and 4B show an example of a flexible vessel, an outer container, and a resistive heating element, as described.

FIG. 5 shows an example of a flexible vessel, an outer container, and a resistive heating element, as described.

FIG. 6 shows an example of a flexible vessel and a resistive heating element, as described.

All figures and depicted figure structures are schematic and are not necessarily to scale.

### DETAILED DESCRIPTION

The present description relates to devices, systems, and methods that use a flexible vessel to contain, transport, and store a material that is capable of being in either an unfrozen liquid state or a frozen (solid) state when contained by the vessel, and may be transformed between the liquid state and the frozen state while contained in the vessel. Also described are methods that involve freezing and thawing the material while the material is contained by the vessel. The devices, systems, and methods use a resistive heating element to apply heat to the vessel that contains a frozen material, to melt the frozen material and change the material from the frozen (solid) state to an unfrozen (liquid) state.

According to example methods and devices, a vessel may contain a biological material that can take both a liquid (unfrozen) form and a solid (frozen) form and may pass between the liquid and the solid form based on temperature. The term “biological material” refers to such a material that is also biologically active. Examples include biological fluids, fluids derived from a biological source, naturally-derived or synthetic pharmaceutical compounds, biologically-derived chemical compounds and structures that include any of the following materials or a liquid or a frozen liquid (solid) that contains any of the following materials: a fluid derived from a culture medium, living cells, cell structures (e.g., a proteins), a cell culture, a buffer solution, an artificial nutrition liquid, a blood fraction, a blood-derived material, a pharmaceutically active fluid, a fluid that is used in a process of preparing a pharmaceutically active liquid, or more broadly a fluid designed to be used in the medical field, including materials that contain viable, living (i.e., “live”) cells. The material is liquid at ambient temperature (e.g., from 15 to 30 degrees Celsius) and becomes solid (a “frozen liquid”) or partly solid by freezing, typically at a temperature below 0 degrees Celsius.

Example systems, devices, and methods of using a flexible polymeric vessel to contain, freeze, and thaw liquid materials such as biologically active materials are described, e.g., in various patent publications, including United States Patent Publication 2018/0021218, and U.S. Pat. Nos. 10,088,106 and 11,207,239. A vessel useful according to the present description may, as desired and in a manner consistent with the present description, include certain features of vessels described in those publications. The vessel may be of a type commonly referred to as a “single use” disposable vessel that is filled once with a liquid biological material, used to store, transport, optionally freeze and thaw, and dispense the liquid biological material, and is then discarded and not reused to contain or dispense another amount of liquid biologically active material.

Generally, a vessel for use according to the present description may be a vessel of a type typically available and useful for containing a liquid, freezing the liquid, and thawing the liquid, which may be a biological material. A useful vessel may have any useful size (internal volume) and shape (e.g., of a type referred to as a “two-dimensional” vessel or “bag” or “pouch,” or a “three-dimensional” vessel, see below); may be prepared from materials that are adapted to perform over a range of temperatures that allow a liquid to be frozen within the vessel, and to allow the frozen liquid to be un-frozen (thawed) by applying heat from a resistive heating element through the vessel; are sterile for use with biologically active materials; have suitable physical strength and thermal conductivity properties; and may be capable of withstanding a sterilization step such as by use of gamma radiation.

Example vessels may have any useful internal volume, such as a volume in a range from 100 milliliters to 100 liters, e.g., up to or greater than 250 or 500 milliliters, or 1, 5, 10, 20, 50, 100, or 500 liters.

The vessel structure includes flexible sidewalls that are assembled to form the vessel to have a vessel interior at inner surfaces of the sidewalls, and an outer surface defined by outer surfaces of the sidewalls. Inner surfaces of the flexible polymeric sidewall define the vessel interior. At least one dispenser (e.g., as a “fitment” or a component of a “fitment”) passes through the vessel to allow fluid to be transferred between the vessel interior and an exterior of the vessel.

A sidewall can be constructed of any useful material or materials and may include a single polymeric layer or two or more polymeric layers that produce a vessel and vessel sidewall that exhibits desired strength, flexibility, permeability (gas barrier properties), and mechanical properties useful for a vessel as described. Examples of useful polymers include polyolefins such as polypropylene and polyethylene (low density polyethylene, very low density polyethylene), ethylene-vinyl acetate copolymer, polyesters, polyamides, polyvinylchloride, polyurethanes, for example. A sidewall may include a layer that functions as a gas and water vapor barrier, such as a layer that includes an ethylene/vinyl alcohol copolymer mixture within a polyamide or an ethylene vinyl acetate copolymer. Further, a sidewall may include a polymer or one or more polymeric layers that has high mechanical strength such as a polyamide.

Certain example vessel sidewalls can be made entirely or partly from one or more fluoropolymers, meaning partially or completely fluorinated (“perfluorinated”) polymers and copolymers. Examples include homopolymers and copolymers referred to as ethylenetetrafluoroethylene (ETFE) polymers, polychlorotrifluoroethylene (PCTFE) polymers, polyvinyl fluoride (PVF) polymers, polyvinylidene fluoride (PVDF) polymers, or two or more of these in a vessel sidewall.

Accordance to certain specific examples, a vessel sidewall that is polymeric or fluoropolymeric (e.g., that comprises, consists essentially of, or consists of one or more fluoropolymers) may desirably exhibit one or more of: (i) an ability to withstand sterilization by gamma irradiation, (ii) an ability to be processed at high shear rates, (iii) an ability to be melt processed, for example by injection-molding, (iv) chemical stability in the presence of a wide range of organic and inorganic liquids and vapors, (v) stability to very cold temperatures including those as low as −150 degrees Celsius and more particularly as low as −190 degrees Celsius when subjected to cold crack testing as specified by ISO 8570:1991 (E), (vi) a water vapor permeability of 2 g/m2.d.bar, and (v) stability to ultraviolet radiation.

The vessel may have a shape that is referred to as a “two-dimensional” vessel, or a shape referred to as a “three-dimensional” vessel. A “two-dimensional” vessel refers to a vessel that is constructed of two opposed sheets of polymeric flexible film as sidewalls, or a single sheet folded to form two opposed sidewalls, with the two sidewalls opposed in a significantly parallel relationship when the vessel is empty, the sidewalls being welded or bonded together at their edges to form a sealed perimeter. The two-dimensional vessel takes the form of a generally flat, planar vessel when empty. The two opposed sidewalls and bonded edges define a vessel interior between the two sidewalls and edges that when filled with liquid forms an inflated, pillow-shaped vessel interior.

A “three-dimensional” vessel has a shape that includes more than the two opposed sidewalls used to form a two-dimensional vessel. An example of a three-dimensional vessel may have sidewalls form a three-dimensional cylinder, a six-sided shape such as a cube or rectangular solid, a gusseted pouch or envelope, or another three-dimensional structure different from a two-dimensional structure when the vessel is filled liquid. A single example of a three-dimensional vessel may include a tubular flexible polymeric sidewall, a bottom flexible polymeric sidewall at a bottom of the tubular flexible polymeric sidewall, a top flexible polymeric sidewall at a top of the tubular flexible polymeric sidewall, and an interior located between the tubular flexible polymeric sidewall, the bottom flexible polymeric sidewall, and the top flexible polymeric sidewall. A one or more fitments may provide a fluid inlet and a fluid outlet at a sidewall to provide fluid communication between the interior and a vessel exterior.

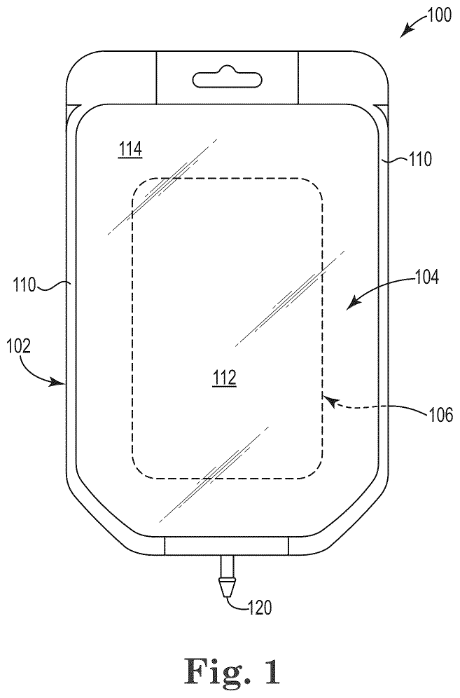

An example of a basic vessel assembly is shown at FIG. 1. Example vessel assembly 100 includes two-dimensional vessel 102 and fitment 120. As illustrated, first and second opposing flexible polymeric sidewalls 104 (front sidewall as illustrated) and 106 (back sidewall as illustrated) are welded or bonded together at their respective edges along a majority of perimeter 110 of vessel 102, interrupted only by fitment 120, to define an interior of vessel 102. The bond or weld formed at edges of first and second sidewalls 104, 106 can be a continuous bond or weld about a majority of perimeter 110 and can include a bonded sealed engagement with fitment 120. Fitment 120 passes between the interior of vessel 102 and an exterior to allow fluid to pass from the interior to the exterior. While a single fitment with a single passage is illustrated, a vessel assembly may optionally include two or more fitments or two or more passages between the interior of vessel 102 and an exterior.

Any suitable welding or bonding technique may be used to attach the first and second sidewalls 104, 106 at their respective edges. Exemplary welding or bonding techniques include heat bonding, impulse welding, laser welding, ultrasonic welding, platen welding, or similar techniques. In example vessels, first and second sidewalls 104 and 106 may be bonded together at their respective edges and at the vessel edges without the need for an added adhesive material placed between the materials of the sidewall layers.

As referenced in the present application, the outer surface of a sidewall of vessel 102 can be considered to have two surface regions: a central surface region 112 (or “central region”) located at the central region of sidewall 104 within the dashed line, and a perimeter surface region 114 (“perimeter region”) located between the dashed line and perimeter 110. In use, while containing a frozen liquid, the interior of vessel 102 will have a larger volume (per area of a sidewall surface) of frozen liquid contained between sidewalls 104 and 106 at central region 112 and a smaller volume (per area of a sidewall surface) of frozen liquid between sidewalls 104 and 106 at perimeter region 114. The thickness of vessel 102 will be greater at central region 112 compared to the thickness of vessel 102 at perimeter region 114.

According to the present description, a vessel that includes a liquid material, e.g., a liquid biological material, that has been frozen to form a solid (frozen) material, e.g., a solid (frozen) biological material, is thawed by applying heat energy to the solid material contained in the vessel, the heat energy being produced by a flexible electrically-resistive heating element.

An electrically-resistive heating element includes electrically-conductive lines that generate heat when electric current is passed through the lines based on the phenomena of joule heating. The lines are located and arranged relative to a vessel sidewall to cause the generated heat to pass through a surface of a vessel. A resistive heating element may be made of metal or a metallic alloy, a ceramic material, or ceramic metals, for example.

The flexible electrically-resistive heating element (sometimes referred to as a “heating element” herein, for convenience) can be located at any position relative to the vessel that will allow heat energy from the heating element to pass through one or more sidewalls of the vessel to reach the frozen material contained at the vessel interior to melt the frozen material. With added details presented herein, a flexible resistive heating element may generally be located at a location such as: within a vessel sidewall, e.g., between layers of a vessel sidewall; in contact with an outer surface or outer layer of a vessel sidewall; or near the vessel sidewall as part of a separate heating device or container that has an interior that is adapted to contain the vessel and to produce heat from an resistive heating element that will heat the vessel while the vessel is contained at the container interior. The heating element generally can be at any location that contacts or is sufficiently near the outer surface of a vessel sidewall to allow heat generated by the heating element to reach and pass through the vessel sidewall.

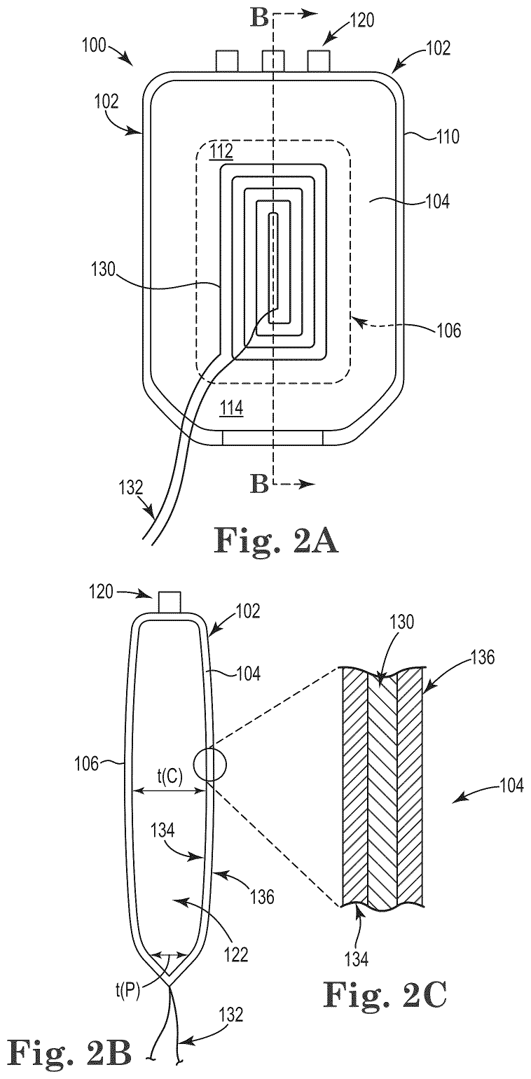

As one specific example, a heating element may be constructed within a flexible sidewall of a vessel as described. Referring to FIGS. 2A, 2B, and 2C, example vessel assembly 100 is shown to include two-dimensional vessel 102, fitment 120, and heating element 130. As illustrated, first and second opposing flexible polymeric sidewalls 104 (front sidewall as illustrated) and 106 (back sidewall as illustrated) are welded or bonded together at their respective edges along a majority of perimeter 110, interrupted by fitment 120, to define an interior 122 of vessel 102. Fitment 120 includes three conduits that allow fluid to pass from interior 122 to the exterior. Heating element 130 includes conductive lines through which electrical current is supplied by electrical leads 132.

Referring to the side view of assembly 110 at FIG. 2B, and the detail view 2C, sidewall 104 is made to include multiple layers that include inner polymeric layer 134 and outer polymeric layer 136, with heating element 130 sandwiched between layer inner layer 134 and outer layer 136.

As shown in the side-view of FIG. 2A, resistive heating element 130 is located at a region of the surface of sidewall 104 that includes a portion of central region 112. At this location, heating element 130 provides heat to interior 122 of two-dimensional vessel 100 at a central (non-perimeter) region of the volume of interior 122, which has a thickness t(c) that is greater than a thickness t(p) of interior 122 at perimeter region 114. The volume (per area of sidewall 104) of interior 122 at central region 112 has a greater thickness and contains a larger amount of frozen liquid (per area of sidewall 104) compared to the volume (per area of sidewall 104) of interior 122 and frozen liquid at perimeter region 114. Locating heating element 130 at the area of the greater thickness at central region 112 allows heating element 130 to apply heat energy directed toward the larger volume of interior 122 at central region 112, with a lower amount of heat flowing to the volume of interior 122 located at perimeter region 114. A result may be more uniform melting of the total (bulk) amount of frozen liquid contained throughout the volume of interior 122; i.e., more uniform heating and melting of frozen liquid at central region 112 and peripheral region 114 compared to melting that is caused by applying a uniform amount of heat energy to all outer surfaces (e.g., all regions) of vessel 100, for example as occurs using a heated water bath.

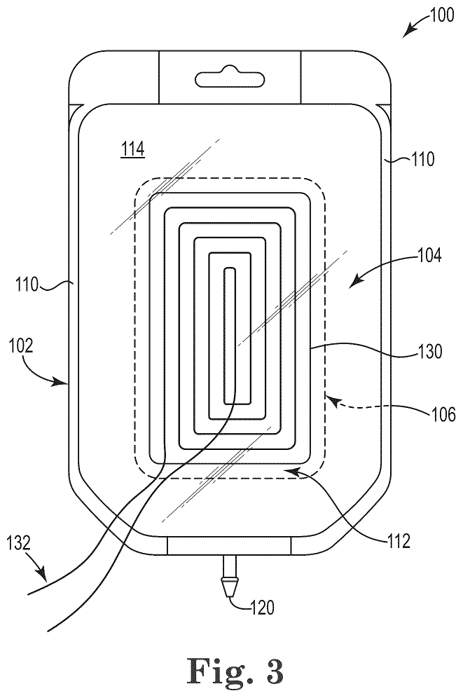

As a different example of a useful location of a heating element relative to a vessel and a vessel sidewall, a heating element may be located at an outer surface of a vessel sidewall and may be permanently or removably attached, e.g., using an adhesive. Referring to FIGS. 3, example vessel assembly 100 is shown to include two-dimensional vessel 102 and fitment 120. First and second opposing flexible polymeric sidewalls 104 and 106 are welded or bonded together at their respective edges along a majority of perimeter 110, interrupted by fitment 120, to define an interior of vessel 102. Resistive heating element 130 is located at a region of the surface of sidewall 104 that includes a portion of central region 112. Heating element 130 includes conductive lines through which electrical current is supplied by electrical leads 132.

At FIG. 3, resistive heating element 130 is located at a region of the surface of sidewall 104 that includes a portion of central region 112. At this location, heating element 130 provides heat to interior 122 of two-dimensional vessel 100 at a central (non-perimeter) portion of the volume of interior 122, which has a thickness (not illustrated) that is greater than a thickness of interior 122 at perimeter region 114.

Still referring to FIG. 3, an example heating element 130 may be removably attached to an outer surface of a vessel sidewall by use of a non-permanent adhesive, such as a pressure-sensitive adhesive. In other examples the heating element 130 may be permanently attached to an outer surface of a vessel sidewall. A heating element that is removably attached from a vessel sidewall may be cleanly and entirely or nearly entirely removed from the vessel sidewall surface without damaging the surface and without damaging the heating element or the vessel sidewall. A permanently attached and non-removable heating element is not designed or intended to allow the heating element to be removed from the vessel and cannot be removed from the vessel without damaging the sidewall, the heating element, or both.

In still other examples of useful arrangements of a vessel and a resistive heating element, the heating element may be a structure or part of a structure that is separate from the vessel but that can engage the vessel in a manner to surround or contain the vessel and apply heat to the outer surface of the vessel and vessel sidewall through the vessel sidewall to melt a frozen liquid contained in the vessel.

A separate device that includes a heating element and that provides heat energy to the vessel may be in the form of a separate heating device, referred to as a “outer heating container,” that is separate from the vessel and that is adapted to surround or contain the vessel for a purpose of heating the vessel while the “outer heating container” surrounds the vessel. The outer heating container may be made of flexible material such as cloth, plastic, or the like, which may be adapted to incorporate a heating element and may be shaped to contain or surround a vessel to place the heating element in proximity to the vessel to allow heat energy produced by the heating element to be applied to the vessel. Examples of outer heating containers may be in the form of a flexible “pouch” or “envelope” that contains an interior that is sized to contain the vessel and to place the heating element in thermal contact with the vessel. Alternately, the outer heating container may be a flexible strip of material that can be contacted with or wrapped around the vessel to place the heating element in thermal contact with the vessel.

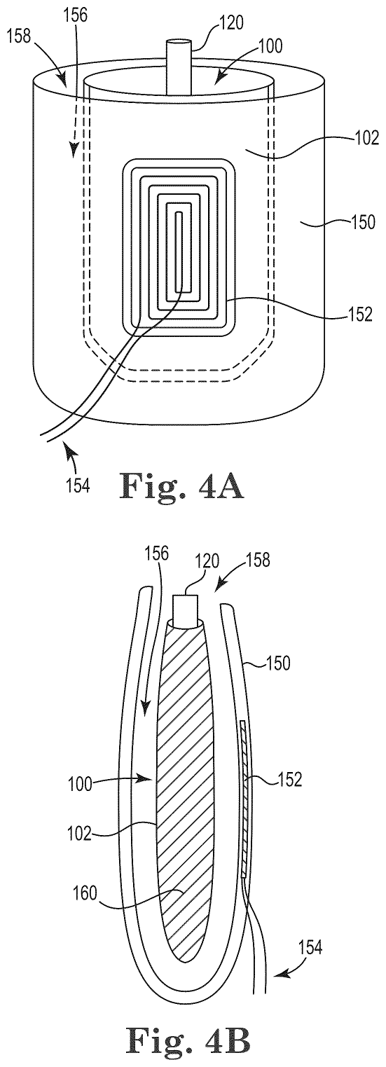

Referring to FIGS. 4A (front view) and 4B (side, cut-away view), illustrated is a vessel assembly 100 as described, contained in an example outer heating container 150 that defines interior 156 and includes opening 158, interior 156, and resistive heating element 152 that includes electrical leads 154. Heating element 152 is included as part of outer container 150. With vessel 102 located at interior 158, heating element 152 is positioned relative to vessel 102 at a location to cause heat energy that is generated by heating element 152 to pass through a sidewall of vessel 102, e.g., at a central region of the sidewall, to heat and thaw a frozen liquid that is contained in vessel 102. Outer heating container 150 includes sidewalls as shown, which may be made of any useful material such as a flexible porous or fibrous material (e.g., a natural or synthetic fibrous cloth or fabric) or a flexible porous or non-porous plastic material. Container 150 may be made of or contain an insulating material that has high thermal insulating value to retain heat energy that is produced by the heating element within the outer heating container.

In use, a vessel assembly such as assembly 100 may be placed through opening 158 of outer heating container 150 to fit within interior 156 of outer heating container 150. Vessel 102 contains frozen liquid 160. Electric current is passed through heating element 152 to generate heat energy that is transmitted through a sidewall of vessel 102 to thaw frozen liquid 160 contained within vessel 102.

Optionally and as illustrated, with vessel assembly 100 held at interior 156 of container 150, heating element 152 is positioned to allow heat that is generated by heating element 152 to pass through a sidewall of vessel 102 at a central region of the sidewall, at an area of greater thickness of vessel 102. The heat generated by heating element 152 is directed to the central region of vessel 102, which contains a greater volume of frozen liquid per surface area of the vessel sidewalls. Applying heat energy toward the central region with no heat being applied to a peripheral region (or alternately applying a greater amount (flux) of heat energy toward the central region and a lower amount (flux) of heat energy toward a peripheral region) can be effective to produce relatively even thawing of a volume of frozen liquid contained within vessel 102 compared to thawing that occurs by applying a uniform amount of heat energy over the entire surface of the vessel such as by thawing in a heated water bath.

A different example of a separate device that includes a heating element and that provides heat energy to a vessel may be in the form of a “protective outer container” that is separate from the vessel and that is adapted to contain the vessel for a purpose of protecting the vessel, and additionally includes a heating element to heat the vessel to thaw a frozen liquid contained in the vessel. A protective outer container can include rigid sidewalls made from metal, rigid plastic, ceramic, or a combination of two or more of these. The protective outer container protects a vessel contained therein and can be used during storage, transport, freezing, and thawing of a contained liquid, and also during delivery of a thawed liquid from the vessel.

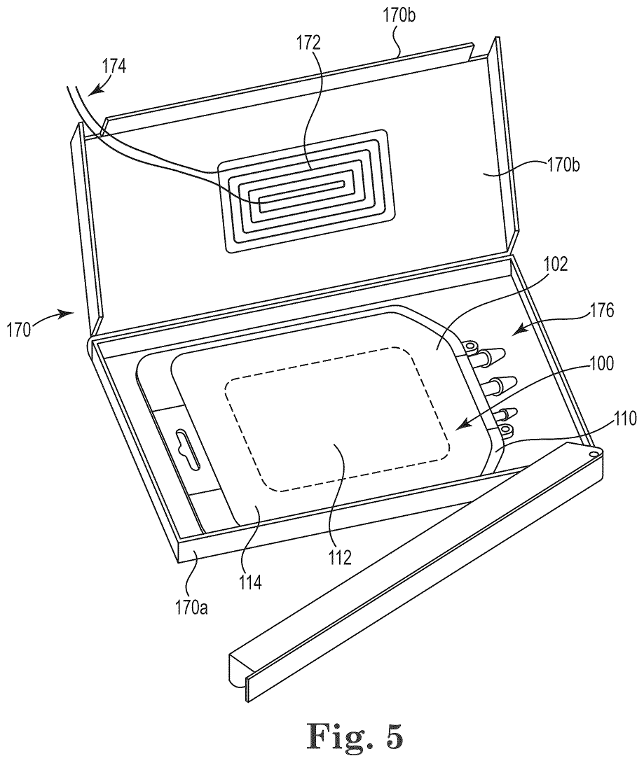

Referring to FIG. 5, illustrated is example vessel assembly 100 as described, contained in an example protective outer container 170 that includes two opposed sides or sidewalls 170a, 170b, connected at a hinge that allows the two sidewalls to be selectively moved, opened and closed relative to each other, to define interior 176 sized to contain vessel assembly 100. One of the sidewalls has at an interior surface resistive heating element 172, including electrical leads 174.

With vessel 102 located at interior 178, heating element 172 is positioned relative to vessel 102 at a location to cause heat energy that is generated by heating element 172 to pass through a sidewall of vessel 102 to heat and thaw a frozen liquid contained in vessel 102. Protective outer container 170 includes sidewalls as shown, which may be made of any useful material such as a relatively rigid metal or plastic that will protect a vessel assembly 100 held at interior 176 from mechanical damage. Container 170 may also include an insulating material, an elastic foam material, or both, between a sidewall and one or more of heating element 172 and vessel assembly 100. An insulating material or a foam material may allow expansion of vessel 102 within interior 176 and may retain heat energy that is produced by heating element 172 within interior 176 of protective outer container 170.

In use, a vessel assembly such as assembly 100 may be placed at interior 176, and sidewalls 170a, 170b can be folded together to form an enclosed interior 176 that contains assembly 100. Vessel 102 contains a frozen liquid. Electric current is passed through heating element 172 to generate heat energy that passes through a sidewall of vessel 102 and causes the frozen liquid contained at the interior of vessel 102 to be thawed. Optionally and as illustrated, while vessel assembly 100 is held at interior 176 of container 170, heating element 172 is positioned to allow heat that is generated by heating element 172 to pass through a sidewall of vessel 102 at central region 112 of the sidewall, which contains a greater volume of frozen liquid per surface area of a vessel sidewall compared to the volume of liquid per surface area of the vessel at peripheral region 114.

According to any of the described example vessel assemblies, vessels, and methods, a resistive heating element used to deliver heat energy to a vessel through a vessel sidewall may optionally be designed, assembled, or used to apply different amounts of heat energy per area of a vessel sidewall (“heat flux”) over two or more different areas (“regions” or “portions”) of a surface of a vessel or vessel sidewall. For example, a heating element can be used to deliver a higher flux of heat energy to a surface of a vessel over an area of a surface of the vessel that contains a larger amount (volume) of frozen liquid, and to deliver a lower flux of heat energy to an area of a surface of the vessel that contains a smaller portion of the frozen biological material.

A flux of heat energy (also referred to as a “heat flux”) is a rate of transfer of heat energy through a given surface (area). A heat flux produced by a heating element may be controlled by different heating element designs and different methods of using a heating element. Heat flux generated by a resistive heating element may be controlled by selecting a pattern of conductive lines that make up the heating element; the size, spacing, composition, and conductivity (resistance) of the lines; the amount of current passed through the lines; or a combination of these. Any one or more of these may be selected and controlled to produce a different magnitude of heat flux generated by a resistive heating element or a portion (area) of a resistive heating element.

During a thawing process, a frozen liquid is initially present within a vessel interior as a solid (bulk) volume of frozen liquid. The shape of the volume of frozen liquid is defined by the shape of the interior of the vessel. For a two-dimensional vessel, a shape of a bulk frozen liquid will have a greater thickness and volume (per area of a vessel sidewall) at a central region and a smaller thickness and volume (per area of vessel sidewall) at a peripheral region. The peripheral region of the bulk frozen liquid is located at the volume of the vessel interior at a peripheral region adjacent to edges and corners of the vessel.

Frozen liquid at peripheral portions of the bulk frozen material will melt more quickly compared to frozen liquid at a central portion of the volume, which have a larger volume, if heat energy is applied to all surfaces of the vessel at the same rate, i.e., when a flux of heat energy is the same over all surfaces of the vessel, as occurs by a step of thawing the frozen liquid contents of the vessel at ambient conditions (in air) or in a heated water bath.

Useful or preferred arrangements of different heat fluxes applied to different areas of a vessel or vessel sidewall can improve the uniformity, evenness, or timing of a method of thawing a frozen liquid contained within a vessel. Example vessels and methods can be used to provide relatively uniform thawing of a bulk liquid contained in a vessel, meaning even or consistent melting of bulk liquid at peripheral regions and central regions of a vessel, e.g., whereby the frozen liquid at peripheral regions of a vessel melts in an amount of time that is similar to the amount of time during which the frozen liquid at the central region melts. Uniformity of thawing may be improved relative to a thawing process that applies heat energy over an entire surface of the vessel, such as by submersing a vessel in a heated water bath, which can result in frozen liquid at a thicker, central region of a vessel taking a relatively longer amount of time to thaw compared to frozen liquid at thinner peripheral regions of the vessel. Furthermore, a total amount of time required to thaw a volume of frozen liquid may be reduced compared to an amount of time required to thaw the frozen liquid at ambient conditions (in ambient, non-convective air).

In example vessels and methods, a flux of heat generated by a resistive heating element and directed to a central region of a vessel may be greater compared to a flux of heat that is directed to a peripheral region of the vessel. In specific examples, an amount (flux) of heat energy may be applied to a central region of a surface of a vessel sidewall, while no amount of heat energy is applied to a peripheral region of the surface of the vessel sidewall. Alternately, a greater amount (flux) of heat energy may be applied at the central region and a lower amount (flux) of heat energy may be applied at a peripheral region.

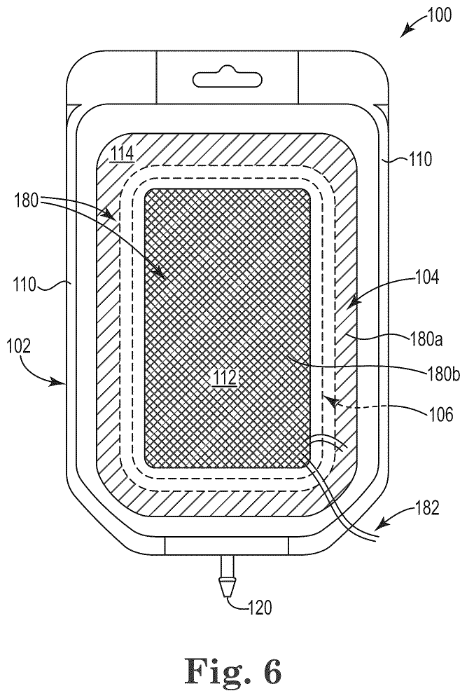

FIG. 6 shows an example of a heating element that is adapted to apply heat fluxes of two different magnitudes at two different regions of a surface of a vessel that contains frozen liquid. FIG. 6 shows a vessel assembly as in FIG. 1, with the addition of multi-region heating element 180. Heating element 180 includes peripheral heating element region 180a at a peripheral region of vessel 102 and central heating element region 180b at a central region of vessel 102. To provide a desired flux of heat energy applied to vessel 102 at their respective regions, each heating element region can have conductive lines of a desired thickness, width, spacing, and composition. Electrical leads 182 connect to both regions, 180a and 180b, and can independently control an amount of current through the regions to be the same or different.

In use, a desired amount of electric current can be passed through each of heating element regions 108a and 108b to produce a desired heat flux from each region. The heat flux produced by region 180a may be less than the heat flux produced by region 180b, to produce relatively even heating and melting of the volume of frozen liquid contained at the interior of vessel 102.

Systems and methods as described allow for rapid and relatively uniform thawing of a bulk volume of frozen biological material in a vessel. Rapid and uniform thawing can have advantages such as to preserve the biological activity of a frozen biological material during thawing, particularly of frozen live cells. Additionally, systems and methods as described can be used for thawing biological materials that include high value medicines such as stem cells or medicines derived from stem cells, at a point of use (e.g., hospital, medical care clinic, home), i.e., at a location of a patient and a location of administering the medicine to the patient, rather than thawing the biological material at a remote location and transporting the material to a point of use in an un-frozen condition.

1. A flexible polymeric vessel and heating element comprising:
a vessel comprising a flexible polymeric sidewall having an inner surface that defines a vessel interior adapted to contain a fluid, and an outer surface,
a flexible resistive heating element adapted to provide heat energy through the flexible polymeric sidewall to the interior.

2. The flexible polymeric vessel and heating element of claim 1, comprising:
the flexible polymeric vessel, and
the heating element attached at an outer surface of flexible polymeric sidewall.

3. The flexible polymeric vessel and heating element of claim 1, comprising a multi-layer flexible polymeric sidewall comprising:
a first layer comprising a first flexible polymeric layer,
a second layer comprising a second flexible polymeric layer, and
the flexible resistive heating element located between the first layer and the second layer.

4. The flexible polymeric vessel and heating element of claim 1, comprising:
the flexible polymeric vessel,
an outer container comprising the resistive heating element and an interior, the flexible polymeric vessel being contained within the interior of the outer container with the resistive heating element being located to allow heat energy from the resistive heating element to pass through the flexible polymeric sidewall to the vessel interior.

5. The flexible polymeric vessel and heating element of claim 4, wherein the outer container comprises a protective housing comprising sidewalls that comprise metal.

6. The flexible polymeric vessel and heating element of claim 4, wherein the outer container comprises a protective housing comprising sidewalls that comprise plastic.

7. The flexible polymeric vessel and heating element of claim 4, wherein the outer container comprises flexible sidewalls made of an insulating material.

8. The flexible polymeric vessel and heating element of claim 7, wherein the flexible vessel is removable from the interior of the outer container.

9. The flexible polymeric vessel and heating element of claim 1, the flexible polymeric vessel further comprising:
a first flexible polymeric sidewall comprising a polymeric sheet having a first sidewall perimeter,
a second flexible polymeric sidewall comprising a second polymeric sheet having a second sidewall perimeter,
a sealed vessel perimeter comprising the first sidewall perimeter bonded to the second sidewall perimeter,
an enclosed interior located between the first flexible polymeric sidewall, the second flexible polymeric sidewall, and the vessel perimeter,
a fluid outlet at the vessel perimeter that provides fluid communication between the interior and a vessel exterior.

10. The flexible polymeric vessel and heating element of claim 1, further comprising:
a tubular flexible polymeric sidewall,
a bottom flexible polymeric sidewall at a bottom of the tubular flexible polymeric sidewall,
a top flexible polymeric sidewall at a top of the tubular flexible polymeric sidewall,
an interior located between the tubular flexible polymeric sidewall, the bottom flexible polymeric sidewall, and the top flexible polymeric sidewall,
a fluid outlet at the top flexible polymeric sidewall that provides fluid communication between the interior and a vessel exterior.

11. The flexible polymeric vessel and heating element of claim 1, wherein the resistive heating element is adapted to provide heat energy to a central region of the vessel.

12. The flexible polymeric vessel and heating element of claim 1, wherein the resistive heating element is adapted to provide a first flux of heat energy to a central region of the vessel and a second flux of heat energy to a peripheral region of the vessel, wherein a magnitude of the first flux is greater than a magnitude of the second flux.

13. The flexible polymeric vessel and heating element of claim 1, containing a biological material.

14. The flexible polymeric vessel and heating element of claim 13, wherein the biological material comprises frozen, living cells.

15. A method of using a flexible polymeric vessel and heating element of claim 1 to store a liquid biological material, the method comprising adding liquid biological material to the flexible polymeric vessel.

16. The method of claim 15, comprising freezing the liquid biological material contained in the flexible polymeric vessel.

17. A method of using a flexible polymeric vessel and heating element of claim 1 to thaw a frozen biological material, the method comprising using the resistive heating element to generate heat energy and applying the heat energy to frozen biological material contained in the flexible polymeric vessel.

18. The method of claim 17, wherein the biological material contains living cells.

19. A method of thawing a frozen biological material, the method comprising:
providing frozen biological material contained in a vessel that comprises a flexible polymeric sidewall having an inner surface that defines a vessel interior adapted to contain a fluid, and an outer surface, and
thawing the biopharmaceutical fluid using a flexible resistive heating element to provide heat energy through the flexible polymeric sidewall to the interior.

20. The method of claim 19, comprising providing heat energy to a central region of the vessel.

21. The method of claim 19, comprising providing a first flux of heat energy to a central region of the vessel, and a second flux of heat energy to a peripheral region of the vessel, wherein a magnitude of the first flux is greater than a magnitude of the second flux.

22. The method of claim 19, comprising, after thawing the biopharmaceutical fluid, administering the biopharmaceutical fluid to a patient.
